(19) United States
(12) Patent Application Publication
(10) Pub. No.: US 2024/0147504 A1
(43) Pub. Date: May 2, 2024

(54) UE-TO-UE RANGING BASED ON SIDELINK GROUPCASTING

(71) Applicant: QUALCOMM Incorporated, San Diego, CA (US)

(72) Inventors: Jing DAI, Beijing (CN); Chao WEI, Beijing (CN); Hao XU, Beijing (CN); Min HUANG, Beijing (CN)

(21) Appl. No.: 18/279,182

(22) PCT Filed: Apr. 21, 2021
(86) PCT No.: PCT/CN2021/088612

§ 371 Date: Aug. 28, 2023

(51) Int. Cl. H04W 72/40; H04L 5/00; H04W 72/0446; H04W 72/232

(52) U.S. Cl. CPC H04W 72/40; H04L 5/0051; H04W 72/0446; H04W 72/232

(57) ABSTRACT

Apparatus, methods, and computer program products for sidelink positioning are provided. An example method includes transmitting or receiving a reservation message reserving sidelink resources for groupcasting of one or more reference signals for a group of multiple UEs including the UE, the sidelink resources for the groupcasting comprising time division multiplexed (TDM) resources for the multiple UEs in the group of multiple UEs. The example method further includes transmitting a reference signal in a resource of the TDM resources.

### INTRODUCTION

The present disclosure relates generally to communication systems, and more particularly, to wireless communication systems with sidelink groupcast.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method at a user equipment (UE) is provided. The method may include transmitting a reservation message reserving sidelink resources for groupcasting of one or more reference signals for a group of multiple UEs including the UE, the sidelink resources for the groupcasting comprising time division multiplexed (TDM) resources for the multiple UEs in the group of multiple UEs. The method may further include transmitting a reference signal in a resource of the TDM resources.

In another aspect of the disclosure, an apparatus at a UE is provided. The apparatus may include means for transmitting a reservation message reserving sidelink resources for groupcasting of one or more reference signals for a group of multiple UEs including the UE, the sidelink resources for the groupcasting comprising TDM resources for the multiple UEs in the group of multiple UEs. The apparatus may further include means for transmitting a reference signal in a resource of the TDM resources.

In another aspect of the disclosure, an apparatus at a UE is provided. The apparatus may include a memory and at least one processor coupled to the memory and configured to transmit a reservation message reserving sidelink resources for groupcasting of one or more reference signals for a group of multiple UEs including the UE, the sidelink resources for the groupcasting comprising TDM resources for the multiple UEs in the group of multiple UEs. The memory and the at least one processor may be further configured to transmit a reference signal in a resource of the TDM resources.

In another aspect of the disclosure a computer-readable storage medium storing computer executable code at a UE may be provided. The code when executed by a processor may cause the processor to transmit a reservation message reserving sidelink resources for groupcasting of one or more reference signals for a group of multiple UEs including the UE, the sidelink resources for the groupcasting comprising TDM resources for the multiple UEs in the group of multiple UEs. The code when executed by a processor may cause the processor to transmit a reference signal in a resource of the TDM resources.

In another aspect of the disclosure, a method at a UE is provided. The method may include receiving a reservation message reserving sidelink resources for groupcasting of one or more reference signals for a group of multiple UEs including the UE, the sidelink resources for the groupcasting comprising TDM resources for the multiple UEs in the group of multiple UEs. The method may further include transmitting a reference signal in a resource of the TDM resources.

In another aspect of the disclosure, an apparatus at a UE is provided. The apparatus may include means for receiving a reservation message reserving sidelink resources for groupcasting of one or more reference signals for a group of multiple UEs including the UE, the sidelink resources for the groupcasting comprising TDM resources for the multiple UEs in the group of multiple UEs. The apparatus may further include means for transmitting a reference signal in a resource of the TDM resources.

In another aspect of the disclosure, an apparatus at a UE is provided. The apparatus may include a memory and at least one processor coupled to the memory and configured to receive a reservation message reserving sidelink resources for groupcasting of one or more reference signals for a group of multiple UEs including the UE, the sidelink resources for the groupcasting comprising TDM resources for the multiple UEs in the group of multiple UEs. The memory and the at least one processor may be further configured to transmit a reference signal in a resource of the TDM resources.

In another aspect of the disclosure a computer-readable storage medium storing computer executable code at a UE may be provided. The code when executed by a processor may cause the processor to receive a reservation message reserving sidelink resources for groupcasting of one or more reference signals for a group of multiple UEs including the UE, the sidelink resources for the groupcasting comprising TDM resources for the multiple UEs in the group of multiple UEs. The code when executed by a processor may cause the processor to transmit a reference signal in a resource of the TDM resources.

In another aspect of the disclosure, a method at abase station is provided. The method may include transmitting downlink control information (DCI) comprising a reservation message reserving sidelink resources for groupcasting of one or more reference signals for a group of multiple UEs including the UE, the sidelink resources for the groupcasting comprising TDM resources for the multiple UEs in the group of multiple UEs. The method may further include receiving hybrid automatic repeat request (HARQ) feedback for the DCI in an uplink transmission from each in the group of multiple UEs.

In another aspect of the disclosure, an apparatus at a base station is provided. The apparatus may include means for transmitting DCI comprising a reservation message reserving sidelink resources for groupcasting of one or more reference signals for a group of multiple UEs including the UE, the sidelink resources for the groupcasting comprising TDM resources for the multiple UEs in the group of multiple UEs. The apparatus may further include means for receiving HARQ feedback for the DCI in an uplink transmission from each in the group of multiple UEs.

In another aspect of the disclosure, an apparatus at a base station is provided. The apparatus may include a memory and at least one processor coupled to the memory and configured to transmit DCI comprising a reservation message reserving sidelink resources for groupcasting of one or more reference signals for a group of multiple UEs including the UE, the sidelink resources for the groupcasting comprising TDM resources for the multiple UEs in the group of multiple UEs. The memory and the at least one processor may be further configured to receive HARQ feedback for the DCI in an uplink transmission from each in the group of multiple UEs.

In another aspect of the disclosure a computer-readable storage medium storing computer executable code at a base station may be provided. The code when executed by a processor may cause the processor to transmit DCI comprising a reservation message reserving sidelink resources for groupcasting of one or more reference signals for a group of multiple UEs including the UE, the sidelink resources for the groupcasting comprising TDM resources for the multiple UEs in the group of multiple UEs. The code when executed by a processor may cause the processor to receive HARQ feedback for the DCI in an uplink transmission from each in the group of multiple UEs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a base station and user equipment (UE) in an access network.

FIG. 4 illustrates an example sidelink communication.

FIGS. 5A-5C illustrate example ranging methods.

FIG. 6A is a diagram illustrating example group ranging.

FIG. 6B is a diagram illustrating example group ranging.

FIG. 7 is a diagram illustrating example group ranging.

FIG. 8 is a diagram illustrating example groupcast transmission.

FIGS. 9A and 9B illustrate example physical sidelink feedback channel (PSFCH).

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus.

FIG. 14 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

In some wireless communication systems, sidelink positioning may be used for UEs. Sidelink positioning may enable UEs to determine relative positioning independent of network coverage. For example, a UE may determine a relative position relative to one or more other UEs including one or more directions and one or more distances relative to each of the one or more other UEs. In some aspects, the sidelink positioning may reduce latency in position determinations due to the positioning process being independent of a network connection. For relative positioning between two UEs, obtaining the absolute locations of the two UEs and then calculating the relative position relative to the other UE may consume computing resources and may take a relatively long amount of time. On the other hand, direct relative positioning, e.g., without first obtaining absolute locations of the UEs, may consume less computing resources and take less time. Such lower latency relative positioning between UEs may be useful for a variety of UEs such as for a vehicle platoon, an unmanned aerial vehicle (UAV) swarm, cooperative robots, or the like.

Reducing the signaling overhead in the sidelink positioning process may result in a more efficient sidelink positioning process. Aspects provided herein present a framework with cooperative group positioning between UEs with reduced signaling overhead for group scheduling. As presented herein, a UE or a base station may schedule and reserve groupcast resources for the group, which in one non-limiting example, the resources may include TDM resources for each of the UEs in the group. Each of the UEs in the group may groupcast, in turn, messages that may include round trip time, using one of the groupcast TDM resources. Each of the UEs may receive the messages groupcasted by other UEs. Each of the messages may include measured time differences between one or more of the prior messages and the current message so that distances may be calculated by each of the UEs based on the measured time differences. By calculating measured time distances based on the groupcasted messages, the UEs within the group may determine position information relative to the other UEs within the group.

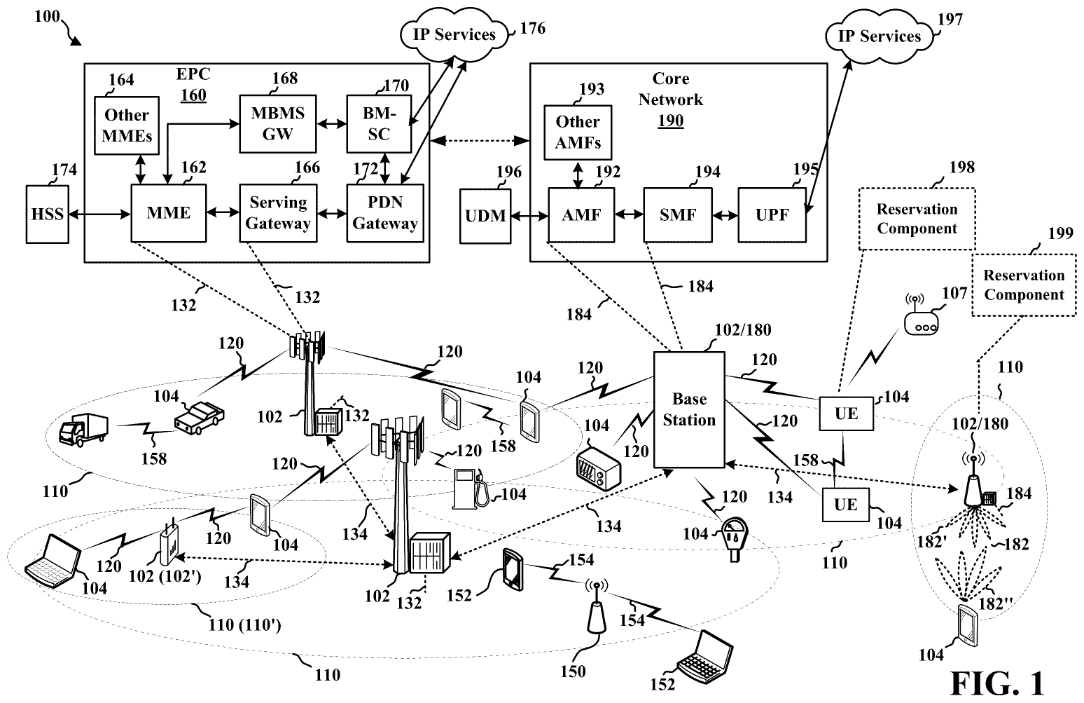

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

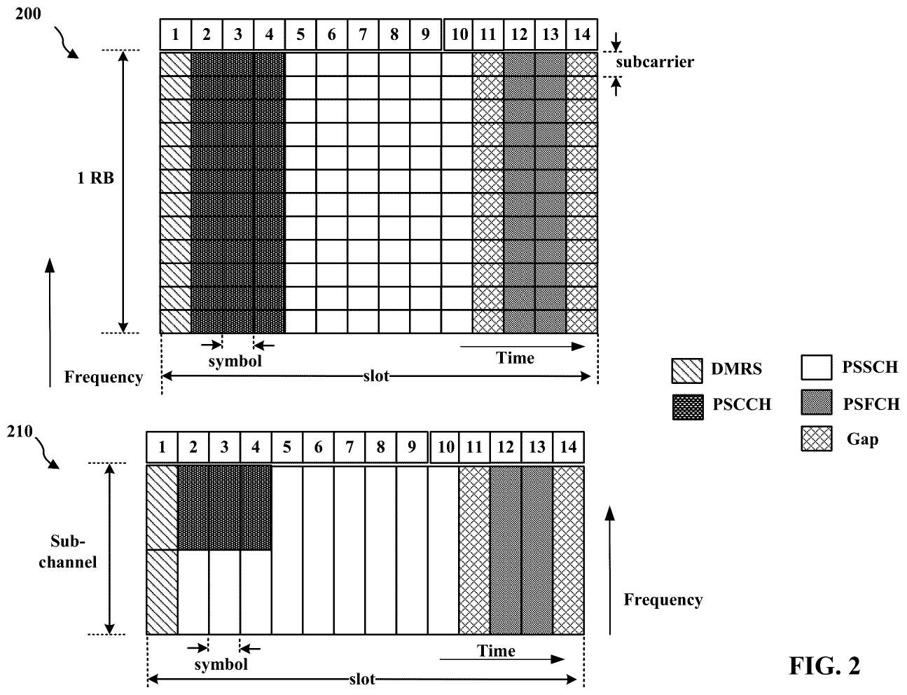

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as abase station), vehicle-to-pedestrian (V2P), cellular vehicle-to-everything (C-V2X), and/or a combination thereof and/or with other devices, which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2X or other D2D communication, such as Proximity Services (ProSe), etc. Communication based on V2X and/or other D2D communication may also be transmitted and received by other transmitting and receiving devices, such as Road Side Unit (RSU) 107, etc. Aspects of the communication may be based on PC5 or sidelink communication e.g., as described in connection with the example in FIG. 2. Although the following description may provide examples for sidelink communication in connection with 5G NR, the concepts described herein may be applicable to other similar areas, such as LTE, LTE-A, CDMA, GSM, and other wireless technologies.

Referring again to FIG. 1, a UE 104, Road Side Unit (RSU) 107, or other sidelink devices may include a reservation component 198. The reservation component 198 may be configured to transmit or receive a reservation message reserving sidelink resources for groupcasting of one or more reference signals for a group of multiple UEs including the UE, the sidelink resources for the groupcasting comprising TDM resources for the multiple UEs in the group of multiple UEs. The reservation component 198 may be further configured to transmit a reference signal in a resource of the TDM resources.

The base station 102 may include a reservation component 199. The reservation component 199 may be configured to transmit DCI comprising a reservation message reserving sidelink resources for groupcasting of one or more reference signals for a group of multiple UEs including the UE, the sidelink resources for the groupcasting comprising TDM resources for the multiple UEs in the group of multiple UEs. The reservation component 199 may be further configured to transmit a reference signal in a resource of the TDM resources.

The wireless communications system (also referred to as a wireless wide area network (WWAN)) includes base stations 102, UEs 104, an Evolved Packet Core (EPC) 160, and a Core Network (e.g., 5GC) 190. The base stations 102 may include macro cells (high power cellular base station) and/or small cells (low power cellular base station). The macro cells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., 51 interface). The base stations 102 configured for NR (collectively referred to as Next Generation RAN (NG-RAN)) may interface with Core Network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or Core Network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Devices may use beamforming to transmit and receive communication. For example, FIG. 1 illustrates that a base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly may be applied by UE 104 or RSU 107 to communicate with another UE 104 or RSU 107, such as based on V2X, V2V, or D2D communication.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The Core Network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the Core Network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or Core Network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may comprise control information in PSCCH and some Res may comprise demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some examples.

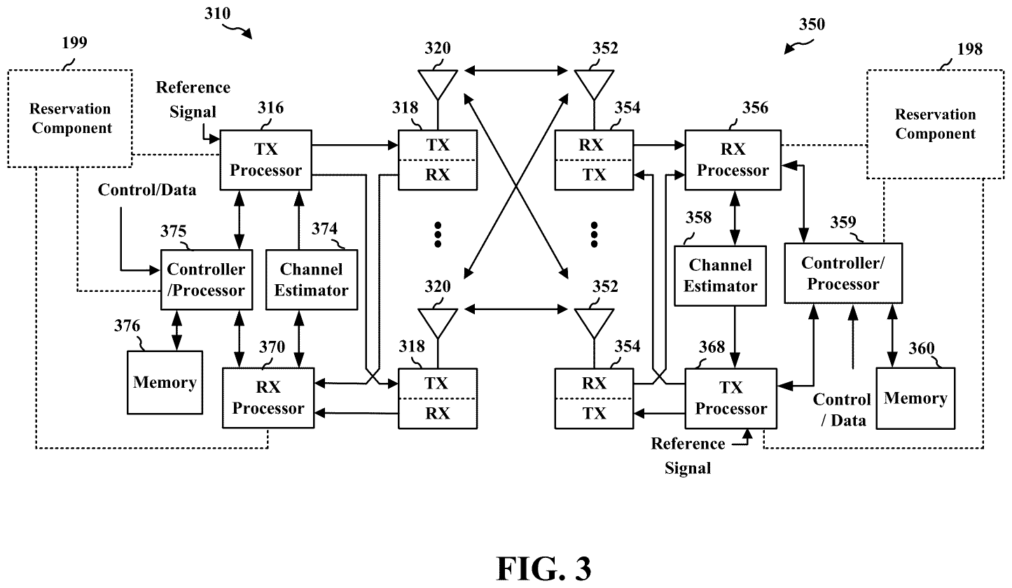

FIG. 3 is a block diagram 300 of a first wireless communication device 310 in communication with a second wireless communication device 350. In some examples, the devices 310 and 350 may communicate based on V2X or other D2D communication. The communication may be based, e.g., on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BP SK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with the reservation component 198 of FIG. 1.

At least one of the TX processor 316, the RX processor 370, and the controller/processor 375 may be configured to perform aspects in connection with the reservation component 199 of FIG. 1.

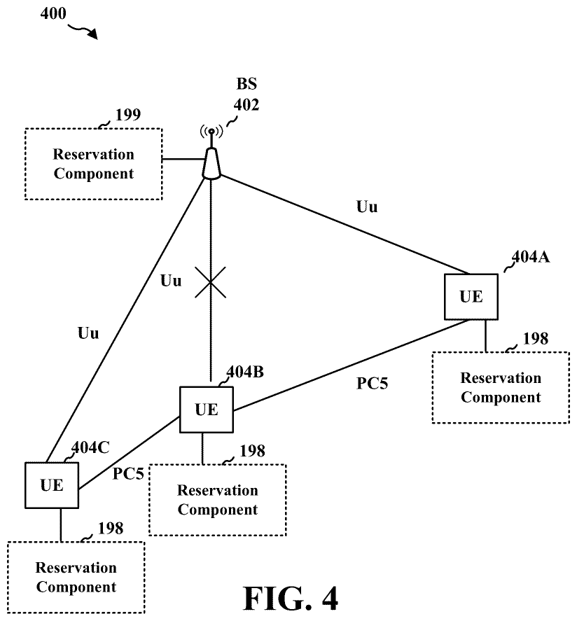

Sidelink communication may include direct wireless communication between a first device (e.g., a first UE or other sidelink device) and a second device (e.g., a second UE or other sidelink device), e.g., without being routed by a base station. A UE may establish a sidelink communication with another with UE with or without receiving a resource allocation for sidelink communication from the base station. For example, as illustrated in example 400 in FIG. 4, a base station 402 may be in communication with a UE 404A via a Uu link and may be unable to communicate with a UE 404B via Uu link. The UE 404A may be in communication with the UE 404B via a PC5 link to facilitate communications for the UE 404B. The UEs 404A and 404B may be further in communication with another UE 404C. The UEs 404A-C may include the reservation component 198 in FIG. 1. The base station 402 may include the reservation component 199 in FIG. 1.

In a first sidelink resource allocation mode (which may be referred to herein as “Mode 1”), centralized resource allocation may be provided by a network entity. For example, a base station 102 or 180 as in FIG. 1, may determine resources for sidelink communication and may allocate resources to different UEs 104 to use for sidelink transmissions. In this first mode, a sidelink UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmissions. In order to coordinate the selection of sidelink resources by individual UEs, each UE may use a sensing technique to monitor for resource reservations by other sidelink UEs and may select resources for sidelink transmissions from unreserved resources.

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that include s reservation information based on a resource reservation field comprised in the SCI. The UE may continuously monitor for (e.g., sense) and decode SCI from peer UEs. The SCI may include reservation information, e.g., indicating the slot and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation.

FIG. 4 illustrates a group of multiple UEs 404A, 404B, and 404C. Although three UEs are illustrated, the group may include any number of UEs. The UEs 404A-404C may perform sidelink positioning (also referred as “ranging”). Sidelink positioning may enable positioning independent of network coverage and may be low latency due to the positioning being independent of network connection. For relative positioning between two UEs, it may be inefficient to obtain the actual locations of the two UEs then calculate the relative position. Direct relative positioning without first obtaining the actual locations of the UEs may be more efficient. Such low latency relative positioning between UEs may be useful for a variety of UEs such as vehicle platoon for collision avoidance, UAV swarm for collision avoidance, cooperative robots, handhelds/wearables used to control other devices (such as a shared bike), smart home entertainment applications (such as smartphone and Television), mission critical operations (such as locating responders), or the like. In addition to 2-node relative positioning, some use cases may use relative positioning for a group of nodes. For example, UAV swarm, vehicle platoon, cooperative robots, and mission critical operations may use relative poisoning for a group of nodes.

Reducing the signaling overhead in the sidelink positioning process may result in a more efficient sidelink positioning process. Aspects provided herein present a framework with cooperative group positioning between UEs with reduced signaling overhead for group scheduling.

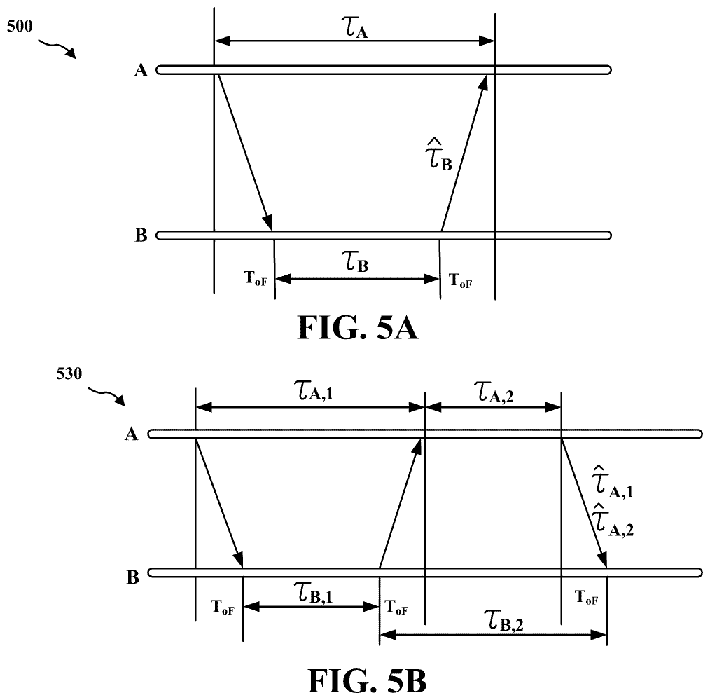

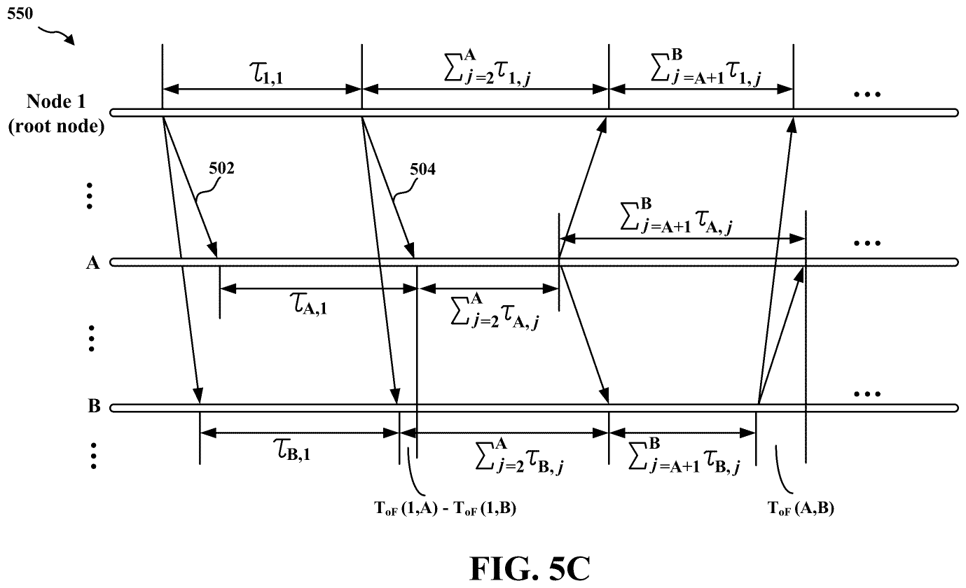

For round trip time (RTT)-based ranging/positioning, ranging may be performed without accurate synchronization among different nodes, and clock drift of each node itself may be the dominant component of measurement error. For example, as illustrated in example 500 of FIG. 5A, for a single-round RTT message exchanging between node A (UE A) and node B (UE B), τ_{A}=2T_{oF}+τ_{B}, where T_{oF}=RTT/2 represent time-of-flight in a single way, τ_{A} represent time delay at node A and τ_{B} represent time delay at node B. For estimation done at UE A, Rx-Tx time difference \hat{τ}_{B} is transmitted by UE B to UE A. In one example, Clock drift may be modelled as \hat{τ}_{A}=(1+e_{A})τ_{A}=k_{A}τ_{A} and \hat{τ}_{B}=(1+e_{B})τ_{B}=k_{B}τ_{B}. e_{A} or e_{B} may represent the deviation from ideal time and may be represented in ppm (parts per million). In some systems, a UE may have clock drift up to ±20 ppm. For estimated ToF by

$${\hat{T}}_{oF} = \frac{1}{2} ( {\hat{τ}}_{A} - {\hat{τ}}_{B} ) ,$$

error may be

$${\hat{T}}_{oF} - {T}_{oF} = \frac{1}{2} ( {\hat{τ}}_{A} - {\hat{τ}}_{B} ) - \frac{1}{2} ( {τ}_{A} - {τ}_{B} ) = \frac{1}{2} ( {e}_{A} {τ}_{A} - {e}_{B} {τ}_{B} ) = {e}_{A} {T}_{oF} + \frac{{τ}_{B}}{2} ( {e}_{A} - {e}_{B} ) .$$

Because T_{oF} may be at a level of tens of nanoseconds (for an example distance of several meters), while τ_{B} is at a level of milliseconds,

$$\frac{{τ}_{B}}{2} ( {e}_{A} - {e}_{B} )$$

may be the dominant part of estimation error. For an example τ_{B}=1 ms, since the worst case of e_{A}−e_{B} is ±40 ppm, the error may be 20 ns (for an example of 6 meters in distance). Therefore, if the target distance error is decimeter- or centimeter-level such as 10 cm (which may result in ⅓ ns), a deviation less than 1 ppm may be tolerated and a deviation more than 1 ppm may result in a distance error larger than the target distance error. However, to achieve 1 ppm, expensive and power-hungry temperature compensated crystal oscillators (TCXOs) that are not practical for a UE may be used.

To decrease the error for a UE, an increase in the time of message exchanging, such as using a double-round message as illustrated in example 530 of FIG. 5B, may be effective. For a general estimation by

$${\hat{T}}_{oF} = \frac{1}{4} ( {\hat{τ}}_{A , 1} - {\hat{τ}}_{B , 1} + {\hat{τ}}_{B , 2} - {\hat{τ}}_{A , 2} ) ( at UE B ,$$

and time difference \hat{τ}_{A,1} and \hat{τ}_{A,2} for message 1 and message 2 are transmitted by UE A to B), error

$${\hat{T}}_{oF} - {T}_{oF} = \frac{1}{2} {T}_{oF} ( {e}_{A} + {e}_{B} ) + \frac{1}{4} ( {e}_{A} - {e}_{B} ) ( {τ}_{B , 1} - {τ}_{A , 2} ) . The \frac{1}{4} ( {e}_{A} - {e}_{B} ) ( {τ}_{B , 1} - {τ}_{A , 2} )$$

may be the dominant part of the error. For symmetrical scheduling with equal time difference τ_{A,1}=τ_{B,2} (and τ_{B,1}=τ_{A,2}), the error may be negligible.

For another estimation by

$${\hat{T}}_{oF} = \frac{{\hat{τ}}_{A , 1} {\hat{τ}}_{B , 2} - {\hat{τ}}_{A , 2} {\hat{τ}}_{B , 1}}{2 ( {\hat{τ}}_{A , 1} + {\hat{τ}}_{A , 2} )} or \frac{{\hat{τ}}_{A , 1} {\hat{τ}}_{B , 2} - {\hat{τ}}_{A , 2} {\hat{τ}}_{B , 1}}{2 ( {\hat{τ}}_{B , 1} + {\hat{τ}}_{B , 2} )} ,$$

the error \hat{T}_{oF}−T_{oF}=e_{B}T_{oF} or e_{A}T_{oF} may also be negligible even without symmetrical scheduling.

A normalized estimation may be

$${\hat{T}}_{oF} = \frac{{\hat{τ}}_{A , 1} {\hat{τ}}_{B , 2} - {\hat{τ}}_{A , 2} {\hat{τ}}_{B , 1}}{{\hat{τ}}_{A , 1} + {\hat{τ}}_{A , 2} + {\hat{τ}}_{B , 1} + {\hat{τ}}_{B , 2}} ,$$

with an negligible error of

$$( \frac{2}{\frac{1}{{k}_{A}} + \frac{1}{{k}_{B}}} - 1 )$$

T_{oF} (value between e_{B}T_{oF} and e_{A}T_{oF}).

For a system with N nodes (such as UEs), for example N=4, time of flight (ToF) between each node which may be

$$( \begin{matrix}N \\ 2\end{matrix} )$$

ToFs (6 ToFs for N=4), for ranging may be estimated. For an estimation with clock drift error mitigated, if the system uses unicast, a total of 6*3=18 messages may be used for a 4-UE system. In addition, because the 6 different ToFs cannot be calculated at a same node, and extra messages may be used to report ToFs calculated at different nodes, to a control center node—thus more than 18 unicast transmissions may be used for a 4-UE system. Aspects provided herein reduce the number of transmissions from the group of multiple UEs to perform positioning by utilizing sidelink groupcast. As illustrated in example 550 in FIG. 5C, a minimum number of N+1 transmissions may be used for a N-UE system with negligible error. A positioning request 502 may be broadcasted by root node 1, which may be any arbitrary node in the system. The root node 1 may initiate a reply solicitation 504 and other nodes may respond to the reply solicitation 504. The reply messages may include all measured time differences that the node has possessed until that time and the reply messages may also be broadcast/groupcasted to all nodes in the system. Therefore, all ToFs between any two nodes A and B may be calculated at root node 1 by:

$${\hat{T}}_{oF} ( A , B ) = \{ \begin{matrix}\frac{1}{2} ( {\sum }_{j = 2}^{B} {\hat{τ}}_{1 , j} - \frac{{\hat{τ}}_{1 , 1}}{{\hat{τ}}_{B , 1}} {\sum }_{j = 2}^{B} {\hat{τ}}_{B , j} ) , & B > A = 1 ( root - to - nonRoot ) \\ {\hat{T}}_{oF} ( A , B ) = \frac{{\hat{τ}}_{1 , 1}}{{\hat{τ}}_{A , 1}} {\sum }_{j = A + 1}^{B} {\hat{τ}}_{A , j} - & B > A > 1 ( both nonRoot ) \\ \frac{{\hat{τ}}_{1 , 1}}{{\hat{τ}}_{B , 1}} {\sum }_{j = A + 1}^{B} {\hat{τ}}_{B , j} + {\hat{T}}_{oF} ( 1 , A ) - & \\ {\hat{T}}_{oF} ( 1 , B ) , & \end{matrix}$$

The error may be e₁T_{oF} (A,B) which may be negligible.

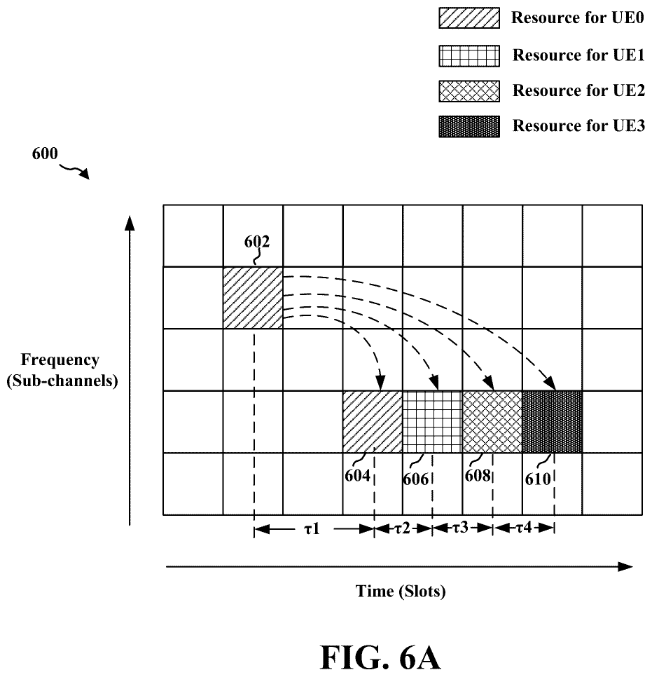

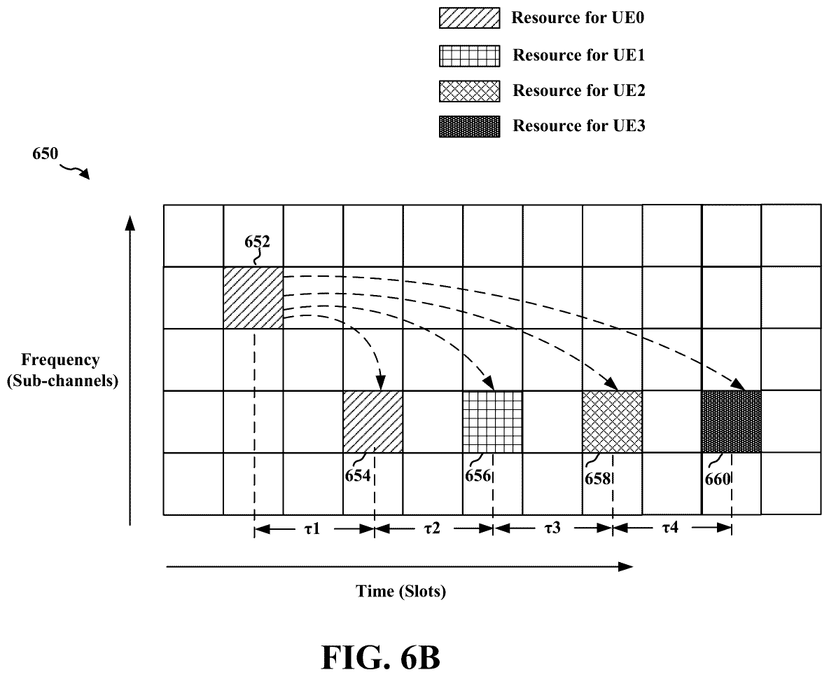

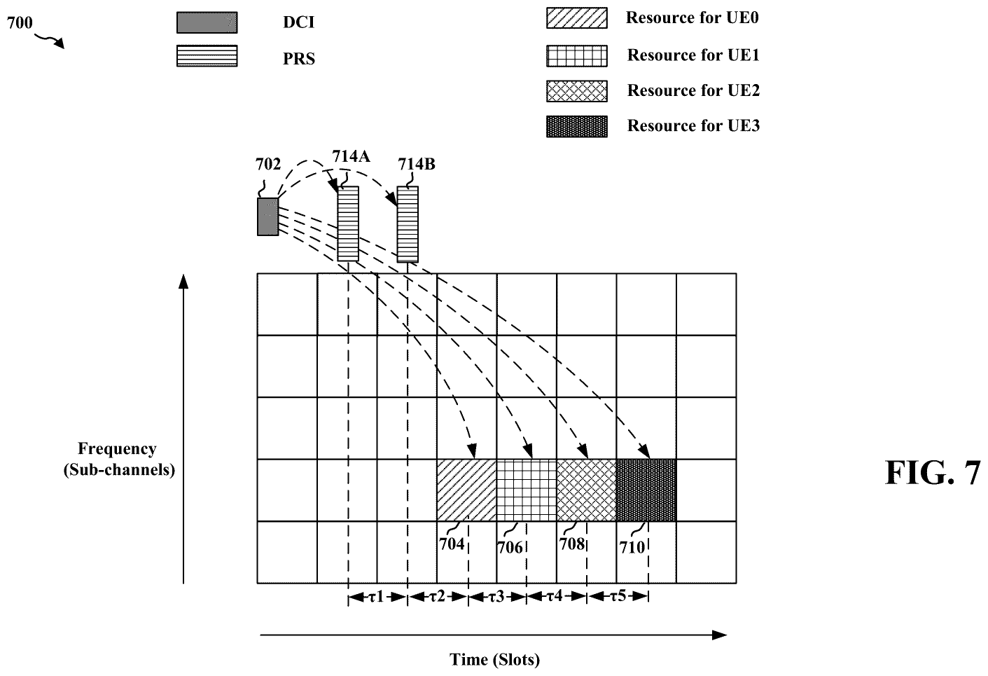

Aspects provided herein, provide support for the cooperative group ranging approach illustrated in FIG. 5C with reduced signaling overhead for group-based scheduling with regard to the ranging between each pair of UEs (nodes). In some aspects, a group of multiple UEs may groupcast in turn based on TDMed sidelink resources reserved by a group reservation as illustrated in example 600 in FIG. 6A, example 650 in FIG. 6B, and example 700 in FIG. 7.

As illustrated in examples 600 and 650, a first UE (UE0) may transmit a positioning request transmitted in resource 602 or resource 652 in a sidelink resource pool which may include a group reservation. In some aspects, the group reservation may be included in a reply solicitation message transmitted in resource 604 or 654. The UE0 may be referred to as the root node for the group of multiple UEs. The term “root node” is merely one example to illustrate the concept of one of the device initiating the positioning measurements and/or reserving the resources for the group. In other aspects, the UE may also be referred to by another name, such as initiating node, reserving node, etc. The ToFs may be accordingly calculated at the UE0. As illustrated in example 700, the group reservation may be transmitted by a base station, such as in a DCI 702. The base station may be the root node. The ToFs may be accordingly calculated at the base station. The UEs in the group, such as UE0, UE1, UE2, and UE3 may be configured with an index within the group (such as {0, 1, 2, 3}) which indicate the resource that may be reserved for the UE to use. For example, the index may indicate that UE0 may use resource 604, resource 654, and resource 704, UE1 may use resource 606, resource 656, and resource 706, UE2 may use resource 608, resource 658, and resource 708, UE3 may use resource 610, resource 660, and resource 710, or the like. In some aspects, the index may be configured before the group reservation is transmitted.

In some aspects, the reserved resources 604, 654, 704, 606, 656, 706, 608, 658, 708, 610, 660, and 710 may have sizes that increase over time because the payload of reported time difference measurements increases for the UEs within the group that transmit in the later TDM slots. For example, as illustrated in example 600, the payload of the transmission by UE1 to UE3 may be the measured {τ₁, τ₂} for UE1, {τ1,τ₂,τ₃} for UE2, and {τ₁,τ₂,τ₃,τ₄} for UE3. In another example, as illustrated in example 700, the payload of the transmission by UE0 to UE3 may be the measured {τ₁,τ₂} for UE0, {τ₁,τ₂,τ₃} for UE1, {τ₁,τ₂,τ₃,τ₄} for UE2, and {τ₁,τ₂,τ₃,τ₄,τ₅} for UE3.

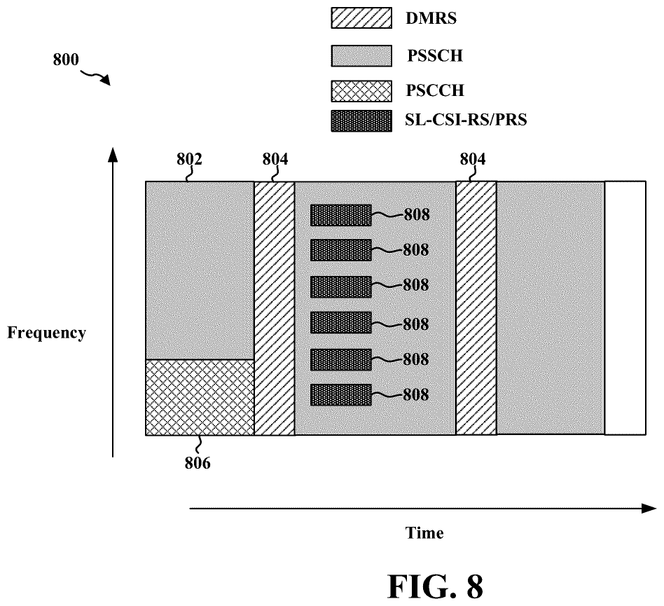

As illustrated in example 800 of FIG. 8, the reference signal (RS) for time difference measurement may be based on DMRS 804 of PSSCH 802, sidelink (SL) CSI-RS 808, or positioning reference signal (PRS) for sidelink. PSCCH 806 may also be included in the same slot. In some aspects, SL-CSI-RS may be triggered by the group reservation 602 or 702. In some aspects, the retransmission of a groupcasted message may or may not include the SL-CSI-RS. In some aspects, the reference signal may be a positioning reference signal (PRS) for sidelink. In each UE's groupcasted transmission, the reported time differences may include all the reported time differences associated with the previous groupcasted transmissions. In some aspects, the reserved resources may be in non-consecutive slots to provide more processing time for the corresponding time difference measurements. For example, as illustrated in example 650 of FIG. 6B, the resources 654, 656, 658, and 660 are in non-consecutive slots. The processing time used may be increased with SCS.

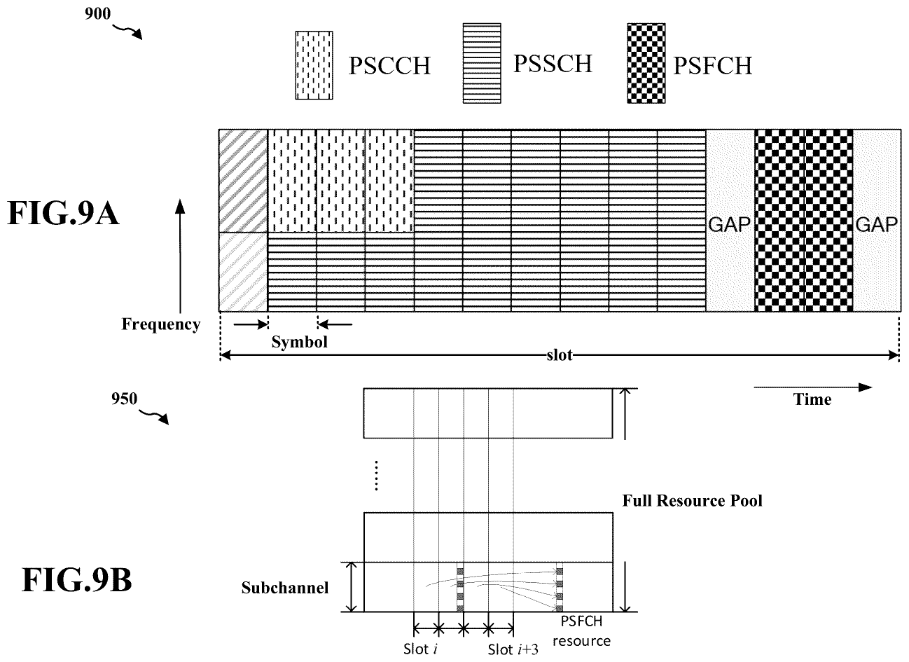

Referring back to example 600, in some aspects, the group reservation may include a configured group-identifier (ID), such as in a destination ID field of SCI-2. In some aspects, the group reservation may be included in the positioning request message transmitted in resource 602. In some aspects, the group reservation may be included in the reply solicitation message transmitted in resource 604. In some aspects, the positioning request message transmitted in resource 602 and the reply solicitation message transmitted in resource 604 may have HARQ feedback from all the other UEs (UE1, UE2, and UE3) in the group. In some aspects, the HARQ feedback may be transmitted in a PSFCH illustrated in examples 900 and 950 in FIGS. 9A and 9B. In some aspects, the PSFCH resource for each UE may indicated by its index within the group. In some aspects, the replying messages from other UEs in the resources 606, 608, and 610 may have HARQ feedback from the root UE0 and may or may not have HARQ feedback from the other UEs. In some aspects, the root UE may ensure the measured time differences are correctly received for calculating the corresponding ToFs by having the HARQ feedback.

Referring back to example 700, in some aspects, the group reservation DCI 702 may be acknowledged by all the UEs via UL signaling, such as PUCCH. The acknowledgment may improve reliability. In some aspects, the retransmission from each UE in resources 704, 706, 708, and 710 may be via UL, such as PUSCH. In some aspects, the time difference measurements based on downlink positioning RS (PRS) may be triggered by the group reservation DCI 712. For example, PRS 714A and 714B may be triggered in example 700, which may mitigate the ranging error due to each UE's clock drift and result in more accurate synchronization with the base station.

FIGS. 9A and 9B illustrate example PSFCH. For example, PSFCH may be placed at the end of a slot. The first PSFCH symbol may be a repetition of the second for automatic gain control (AGC) settling. A gap symbol may be placed before and after PSFCH symbols. In a resource pool, PSFCH resource may be configured with a periodicity of N_{PSSCH}^{PSFCH}∈{1,2,3,4} slots, and a bitmap may represent the PRBs that have PSFCH resource. For example, a minimum time gap (minTimeGap) of {2,3} slots may be configured. For a PSSCH, the associated PSFCH may be in the first slot that includes PSFCH resources. In frequency-domain, the [(i+j·N_{PSSCH}^{PSFCH})·M_{subch,slot}^{PSFCH},(i+1+j·N_{PSSCH}^{PSFCH})·M_{subch,slot}^{PSFCH}−1] PRBs from the PRBs having PSFCH resources as configured by the bitmap, may be associated with slot i and subchannel j, where N_{PSSCH}^{PSFCH} is the PSFCH periodicity, and M_{subch,slot}^{PSFCH} is an integer number of PSFCH-PRBs allocated to each subchannel and slot. Each PRB with PSFCH resources may have N_{CS}^{PSFCH}∈{1,2,3,6} resources associated with different cyclic shifts.

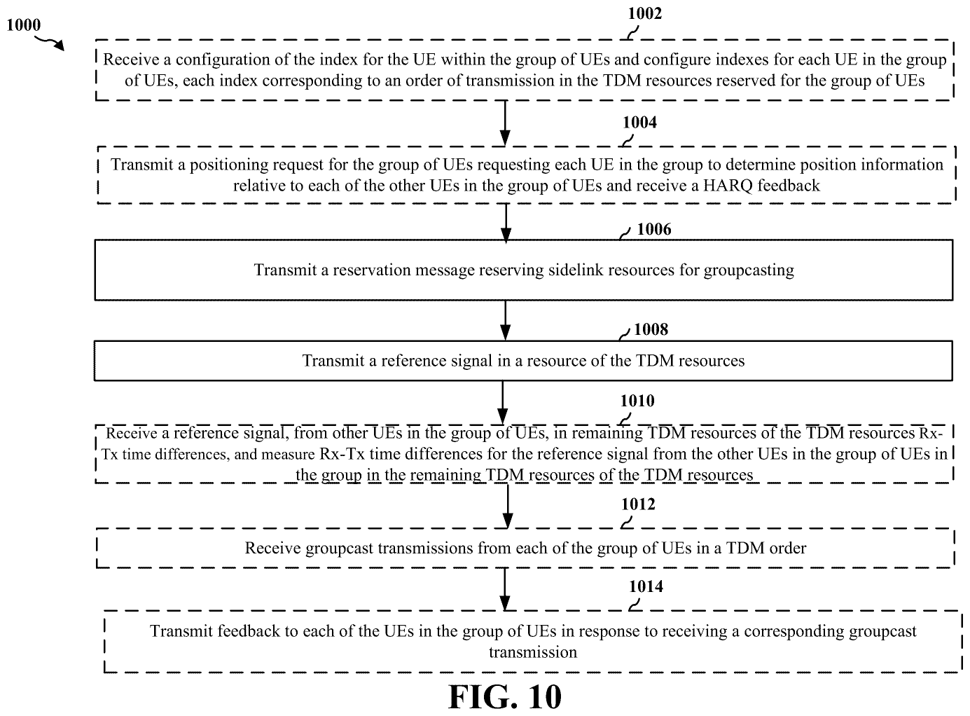

FIG. 10 is a flowchart 1000 of a method of wireless communication. The method may be performed by a UE (e.g., the UE 104, the UE 402A/B/C, the root node UE described in connection with FIGS. 5A-5C, FIGS. 6A-6B, and FIG. 7; the apparatus 1302). Optional steps are illustrated in dashed lines. The steps are not necessarily illustrated in chronological order. The method enables cooperative group positioning between UEs with reduced signaling overhead for group scheduling.

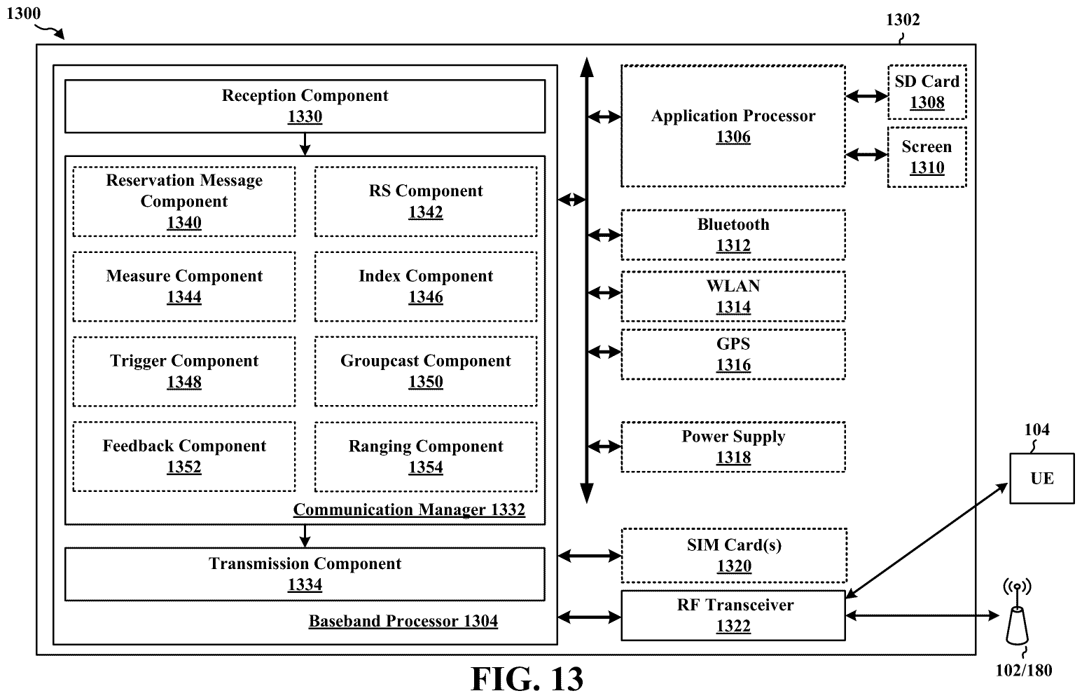

At 1006, the UE may transmit a reservation message reserving sidelink resources for groupcasting of one or more reference signals for a group of multiple UEs including the UE, the sidelink resources for the groupcasting comprising TDM resources for the multiple UEs in the group of multiple UEs. In some aspects, the reservation message may correspond the group reservation described in connection with examples 600 and 650. In some aspects, prior to transmitting the reservation message, at 1004, the UE may transmit a positioning request for the group of multiple UEs requesting each UE in the group of multiple UEs to determine relative position information relative to each of the other UEs in the group of multiple UEs. In some aspects, the positioning request may correspond with the positioning request previously described in connection with examples 550, 600, and 650. In some aspects, the positioning request may include the reservation message. In some aspects, a response solicitation message may include the reservation message. In some aspects, the UE may receive, from each UE in the group of multiple UEs, a HARQ feedback for at least one of the positioning request or the reservation message. In some aspects, the HARQ feedback may be received by feedback component 1352 in FIG. 13. In some aspects, 1006 may be performed by reservation message component 1340 in FIG. 13. In some aspects, the UE may trigger the other UEs in the group of multiple UEs to transmit a CSI-RS in one resource of the TDM resources based on transmitting the reservation message for the TDM resources for the groupcast. In some aspects, the trigger may be performed by the trigger component 1348. In some aspects, 1004 may be performed by ranging component 1354. In some aspects, the reservation message includes a group identifier for the group of multiple UEs. In some aspects, the reservation message indicates a positioning request for the group of multiple UEs requesting each UE in the group of multiple UEs to determine relative position information relative to each of the other UEs in the group of multiple UEs. In some aspects, the UE may receive HARQ feedback for the positioning request from each of the UEs in the group.

At 1008, the UE may transmit a reference signal in a resource of the TDM resources. In some aspect, 1008 may be performed by RS component 1342 in FIG. 13. In some aspects, the TDM resources are consecutive in time. In some aspects, the TDM resources are non-consecutive in time. In some aspects, the TDM resources may correspond with the TDM resources described in connection with example 600 and example 650. In some aspects, transmitting the reference signal further includes transmitting the reference signal in the resource based on an index of the UE within the group of multiple UEs. In some aspects, the reference signal includes a DMRS of a PSSCH, such as DMRS 804. In some aspects, the reference signal includes a sidelink CSI-RS, such as SL-CSI-RS 808. In some aspects, the reference signal includes a sidelink PRS.

In some aspects, the UE may receive a configuration of the index for the UE within the group of multiple UEs at 1002. In some aspects, 1002 may be performed by index component 1346. In some aspects, the index may correspond with the index described in connection with example 600 and example 650. In some aspects, the UE may configure indexes for each UE in the group of multiple UEs, each index corresponding to an order of transmission in the TDM resources reserved for the group of multiple UEs, at 1002. In some aspects, 1002 may be performed by index component 1346 in FIG. 13.

At 1010, the UE may receive a reference signal, from other UEs in the group of multiple UEs, in remaining TDM resources of the TDM resources reception-transmission (Rx−Tx) time differences, and measure Rx−Tx time differences (such as the τ1, τ2, τ3, and τ4 in FIGS. 6A and 6B) for the reference signal from the other UEs in the group of multiple UEs in the remaining TDM resources of the TDM resources. In some aspects, 1010 may be performed by the measure component 1344.

At 1012, the UE may receive groupcast transmissions from each UE of the group of multiple UEs in accordance with an associated TDM order representing an order of transmission for the each UE of the group of multiple UEs in the TDM resources. In some aspects, the groupcast transmissions may correspond with the transmissions at resources 606, 656, 608, 658, 610, and 660. In some aspects, each groupcast transmission reports one or more time differences for previous groupcasted transmissions in the TDM resources, such as described in connection with example 600 and example 650. In some aspects, 1012 may be performed by the groupcast component 1350.

At 1014, the UE may transmit feedback to each of the UEs in the group of multiple UEs in response to receiving a corresponding groupcast transmission. In some aspects, 1014 may be performed by feedback component 1352 in FIG. 13. For example, the feedback may correspond with the transmissions at resources 606, 656, 608, 658, 610, and 660.

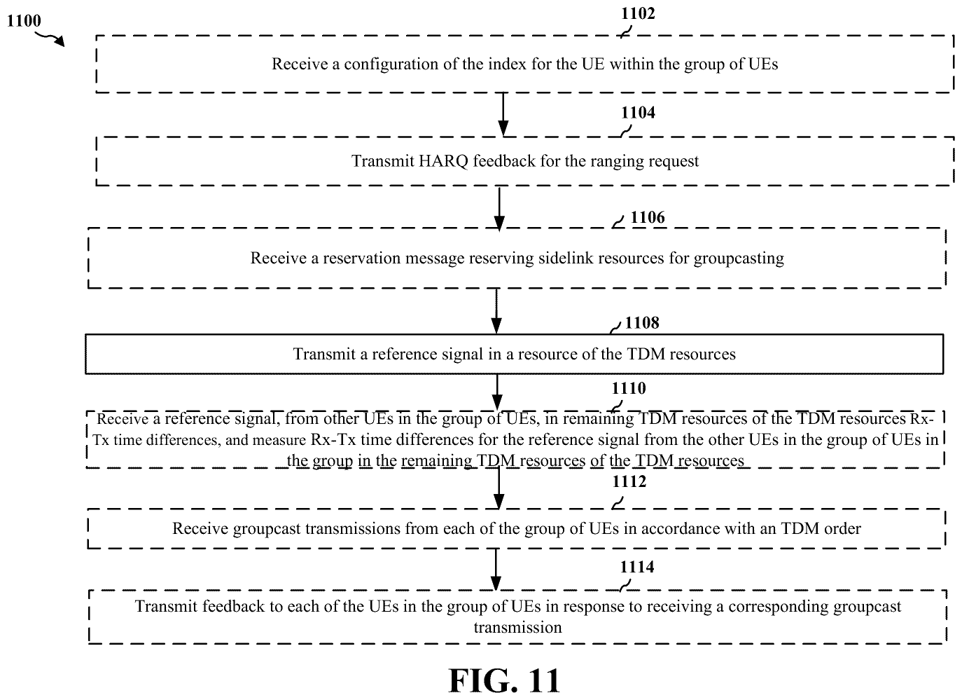

FIG. 11 is a flowchart 1100 of a method of wireless communication. The method may be performed by a UE (e.g., the UE 104, the UE 402A/B/C, the non-root node UEs described in connection with FIGS. 5A-5C, FIGS. 6A-6B, and FIG. 7; the apparatus 1302). Optional steps are illustrated in dashed lines. The steps are not necessarily illustrated in chronological order. The method enables cooperative group positioning between UEs with reduced signaling overhead for group scheduling.

At 1106, the UE may receive a reservation message reserving sidelink resources for groupcasting of one or more reference signals for a group of multiple UEs including the UE, the sidelink resources for the groupcasting comprising TDM resources for the multiple UEs in the group of multiple UEs. In some aspects, the reservation message may be received from a base station or a root node UE and may correspond the group reservation described in connection with examples 600, 650, and 700. In some aspects, prior to transmitting the reservation message, at 1104, the UE may receive a positioning request for the group of multiple UEs requesting each UE in the group of multiple UEs to determine relative position information relative to each of the other UEs in the group of multiple UEs. In some aspects, the positioning request may correspond with the positioning request previously described in connection with examples 550, 600, 650, and 700. In some aspects, the positioning request may include the reservation message. In some aspects, a response solicitation message may include the reservation message. In some aspects, the UE may transmit a HARQ feedback for at least one of the positioning request or the reservation message. In some aspects, the HARQ feedback may be transmitted by feedback component 1352 in FIG. 13. In some aspects, 1006 may be performed by reservation message component 1340 in FIG. 13. In some aspects, the UE may trigger transmission of a CSI-RS in the TDM resources in response to receiving the reservation message for the TDM resources for the groupcast. In some aspects, the trigger may be performed by the trigger component 1348. In some aspects, 1004 may be performed by ranging component 1354. In some aspects, the reservation message includes a group identifier for the group of multiple UEs. In some aspects, the reservation message indicates a positioning request for the group of multiple UEs requesting each UE in the group of multiple UEs to determine relative position information relative to each of the other UEs in the group of multiple UEs. In some aspects, the UE may transmit HARQ feedback for the positioning request to a base station or a root node UE. In some aspects, the DCI is included in a DCI from a base station.

At 1108, the UE may transmit a reference signal in a resource of the TDM resources. In some aspect, 1108 may be performed by RS component 1342 in FIG. 13. In some aspects, the TDM resources are consecutive in time. In some aspects, the TDM resources are non-consecutive in time. In some aspects, the TDM resources may correspond with the TDM resources described in connection with examples 600, 650, and 700. In some aspects, transmitting the reference signal further includes transmitting the reference signal in the resource based on an index of the UE within the group of multiple UEs. In some aspects, the reference signal includes a DMRS of a PSSCH, such as DMRS 804. In some aspects, the reference signal includes a sidelink CSI-RS, such as SL-CSI-RS 808. In some aspects, the reference signal includes a PRS for sidelink. In some aspects, the UE may measure a downlink reference signal from the base station and may adjust for clock drift prior to transmitting in the one resource of the TDM resources reserved for the group of multiple UEs.

In some aspects, the UE may receive a configuration of the index for the UE within the group of multiple UEs at 1002. In some aspects, 1002 may be performed by index component 1346. In some aspects, the index may correspond with the index described in connection with example 600 and example 650. In some aspects, the UE may configure indexes for each UE in the group of multiple UEs, each index corresponding to an order of transmission in the TDM resources reserved for the group of multiple UEs, at 1002. In some aspects, 1002 may be performed by index component 1346 in FIG. 13.

At 1010, the UE may receive a reference signal, from other UEs in the group of multiple UEs, in remaining TDM resources of the TDM resources reception-transmission (Rx−Tx) time differences, and measure Rx−Tx time differences (such as the τ1, τ2, τ3, and τ4 in FIGS. 6A and 6B) for the reference signal from the other UEs in the group of multiple UEs in the remaining TDM resources of the TDM resources. In some aspects, 1010 may be performed by the measure component 1344. Example aspects of such measurements are described in connection with FIGS. 6A/6B and FIG. 7.

At 1012, the UE may receive groupcast transmissions from each UE of the group of multiple UEs in accordance with an associated TDM order representing an order of transmission for the each UE of the group of multiple UEs in the TDM resources. In some aspects, the groupcast transmissions may correspond with the transmissions at resources 606, 656, 608, 658, 610, and 660. In some aspects, each groupcast transmission reports one or more time differences for previous groupcasted transmissions in the TDM resources, such as described in connection with example 600 and example 650. In some aspects, 1012 may be performed by the groupcast component 1350.

At 1114, the UE may transmit feedback to each of the UEs in the group of multiple UEs in response to receiving a corresponding groupcast transmission. In some aspects, 1014 may be performed by feedback component 1352 in FIG. 13. For example, the feedback may correspond with the transmissions at resources 606, 656, 608, 658, 610, and 660.

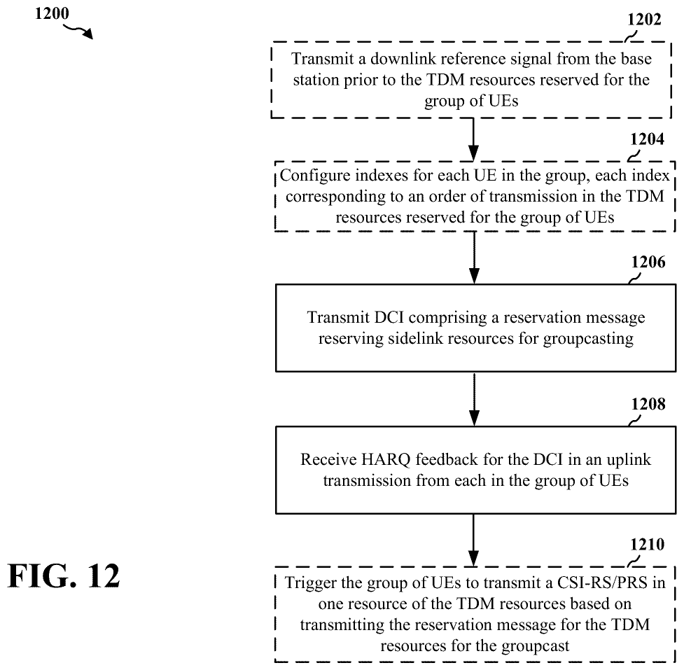

FIG. 12 is a flowchart 1200 of a method of wireless communication. The method may be performed by a base station (e.g., the base station 102/180, the base station 402, the base station transmitting the DCI 702; the apparatus 1402. Optional steps are illustrated in dashed lines. The steps are not necessarily illustrated in chronological order. The method supports cooperative group positioning between UEs with reduced signaling overhead for group scheduling.

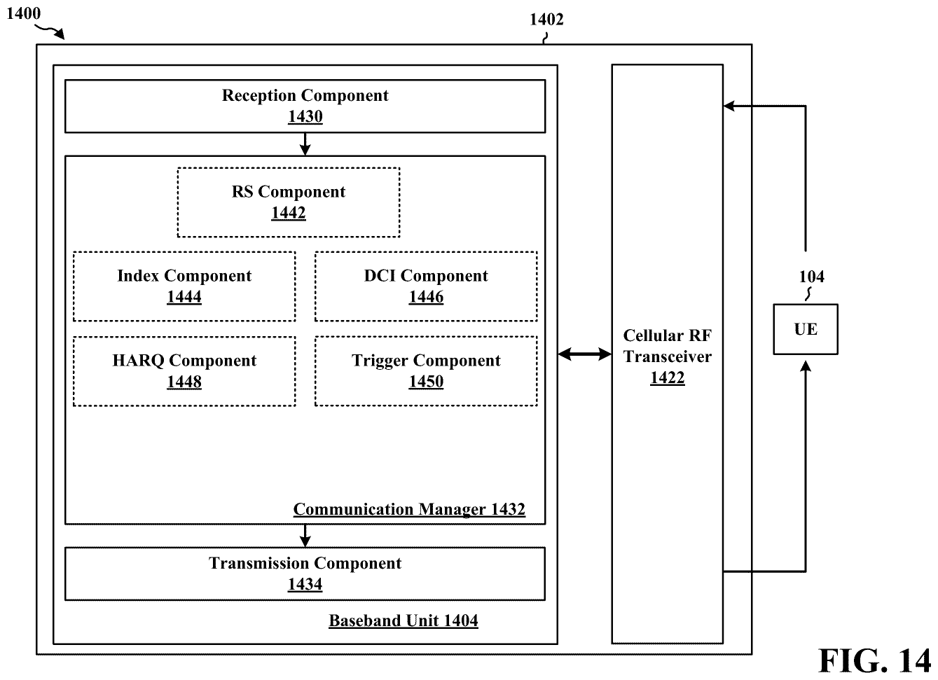

At 1202, the base station may transmit a downlink reference signal from the base station prior to the TDM resources reserved for the group of multiple UEs. In some aspects, 1202 may be performed by RS component 1442 in FIG. 14.

At 1204, the base station may configure indexes for each UE in the group, each index corresponding to an order of transmission in the TDM resources reserved for the group of multiple UEs. In some aspects, 1204 may be performed by index component 1444 in FIG. 14. In some aspects, the TDM resources are consecutive in time as illustrated in FIG. 7. In some aspects, the TDM resources are non-consecutive in time. In some aspects, the indexes may be the indexes described in connection with FIG. 7. In some aspects, a later resource in the TDM resources has a bigger size relative to an earlier resource in the TDM resources.

At 1206, the base station may transmit DCI comprising a reservation message reserving sidelink resources for groupcasting of one or more reference signals for a group of multiple UEs including the UE, the sidelink resources for the groupcasting comprising TDM resources for the multiple UEs in the group of multiple UEs. In some aspects, 1206 may be performed by DCI component 1446 in FIG. 14. In some aspects, the DCI may correspond with the DCI 702. At 1208, the base station may receive HARQ feedback for the DCI in an uplink transmission from each in the group of multiple UEs. In some aspects, 1208 may be performed by HARQ component 1448 in FIG. 14. In some aspects, the reservation message includes a group identifier for the group of multiple UEs.

At 1210, the base station may trigger the group of multiple UEs to transmit a CSI-RS in the TDM resources based on transmitting the reservation message for the TDM resources for the groupcast. Additionally, or alternatively, the base station may trigger the group of multiple UEs to transmit a PRS in the TDM resources based on transmitting the reservation message for the TDM resources for the groupcast. In some aspects, 1210 may be performed by trigger component 1450 in FIG. 14. In some aspects, the trigger may be the DCI.

FIG. 13 is a diagram 1300 illustrating an example of a hardware implementation for an apparatus 1302. In some aspects, the apparatus 1302 may be a UE or a component of a UE. The apparatus 1302 may include a baseband processor 1304 (also referred to as a modem) coupled to an RF transceiver 1322. In some aspects, the baseband processor may be a cellular baseband processor, and the RF transceiver may be a cellular RF transceiver. The apparatus may include one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, and/or a power supply 1318. The baseband processor 1304 communicates through the RF transceiver 1322 with the UE 104 and/or BS 102/180. The baseband processor 1304 may include a computer-readable medium/memory. The computer-readable medium/memory may be non-transitory. The baseband processor 1304 is responsible for general processing, including the execution of software stored on the computer-readable medium/memory. The software, when executed by the baseband processor 1304, causes the baseband processor 1304 to perform the various functions described supra. The computer-readable medium/memory may also be used for storing data that is manipulated by the baseband processor 1304 when executing software. The baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband processor 1304. The baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the additional modules of the apparatus 1302.

The communication manager 1332 may include a reservation message component 1340 that may transmit or receive a reservation message reserving sidelink resources for groupcasting of one or more reference signals for a group of multiple UEs including the UE, the sidelink resources for the groupcasting comprising TDM resources for the multiple UEs in the group of multiple UEs, e.g., as described in connection with 1006 and 1106 in FIGS. 10 and 11. The communication manager 1332 may further include a RS component 1342 that may transmit a reference signal in a resource of the TDM resources, e.g., as described in connection with 1008 and 1108 in FIGS. 10 and 11. The communication manager 1332 may further include a measure component 1344 that may measure TDM transmissions of the reference signal from the other UEs in the group in remaining TDM resources reserved by the UE, e.g., as described in connection with 1010 and 1110 in FIGS. 10 and 11. The communication manager 1332 may further include an index component 1346 that may receive a configuration of the index for the UE within the group of multiple UEs or configure indexes for each UE in the group of multiple UEs, each index corresponding to an order of transmission in the TDM resources reserved for the group of multiple UEs, e.g., as described in connection with 1002 and 1102 in FIGS. 10 and 11. The communication manager 1332 may further include a trigger component 1348 that may trigger the UEs in the group of multiple UEs to transmit a CSI-RS in the TDM resources based on transmitting the reservation message for the TDM resources for the groupcast or trigger transmission of a CSI-RS in the TDM resources in response to receiving the reservation message for the TDM resources for the groupcast. The communication manager 1332 may further include a groupcast component 1350 that may receive groupcast transmissions from each UE of the group of multiple UEs in accordance with an associated TDM order representing an order of transmission for the each UE of the group of multiple UEs in the TDM resources, wherein each groupcast transmission reports one or more time differences for previous groupcasted transmissions in the TDM resources, e.g., as described in connection with 1012 and 1112 in FIGS. 10 and 11. The communication manager 1332 may further include a feedback component 1352 that may transmit feedback to each of the UEs in the group of multiple UEs in response to receiving a corresponding groupcast transmission, e.g., as described in connection with 1014 and 1114 in FIGS. 10 and 11. The communication manager 1332 may further include a feedback component 1354 that may transmit or receive a positioning request for the group of multiple UEs requesting each UE in the group of multiple UEs to determine relative position information relative to each of the other UEs in the group of multiple UEs, e.g., as described in connection with 1004 and 1104 in FIGS. 10 and 11.

The apparatus may include additional components that perform each of the blocks of the algorithm in the flowcharts of FIGS. 10 and 11. As such, each block in the flowcharts of FIGS. 10 and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband processor 1304, includes means for transmitting a reservation message reserving sidelink resources for groupcasting of one or more reference signals for a group of multiple UEs including the UE, the sidelink resources for the groupcasting comprising TDM resources for the multiple UEs in the group of multiple UEs (e.g., the reservation message component 1340 or the transceiver 1322). The baseband processor 1304 may further include means for transmitting a reference signal in a resource of the TDM resources (e.g., the RS component 1342 or the transceiver 1322). The baseband processor 1304 may further include means for receiving a reference signal, from other UEs in the group of multiple UEs, in remaining TDM resources of the TDM resources and means for measuring Rx−Tx time differences for the reference signal from the other UEs in the group of multiple UEs in the remaining TDM resources of the TDM resources (e.g., the measure component 1344). The baseband processor 1304 may further include means for receiving a configuration of the index for the UE within the group of multiple UEs (e.g., the index component 1346 or the transceiver 1322). The baseband processor 1304 may further include means for configuring indexes for each UE in the group of multiple UEs, each index corresponding to an order of transmission in the TDM resources reserved for the group of multiple UEs (e.g., the index component 1346 or the transceiver 1322). The baseband processor 1304 may further include means for triggering the UEs in the group of multiple UEs to transmit a CSI-RS in the TDM resources based on transmitting the reservation message for the TDM resources for the groupcast (e.g., the trigger component 1348 or the transceiver 1322). The baseband processor 1304 may further include means for receiving groupcast transmissions from each UE of the group of multiple UEs in accordance with an associated TDM order representing an order of transmission for the each UE of the group of multiple UEs in the TDM resources, wherein each groupcast transmission reports one or more time differences for previous groupcasted transmissions in the TDM resources (e.g., the groupcast component 1350 or the transceiver 1322). The baseband processor 1304 may further include means for transmitting feedback to each of the UEs in the group of multiple UEs in response to receiving a corresponding groupcast transmission (e.g., the feedback component 1352 or the transceiver 1322). The baseband processor 1304 may further include means for receiving HARQ feedback for the positioning request from each of the UEs in the group (e.g., the feedback component 1352 or the transceiver 1322). The baseband processor 1304 may further include means for transmitting a positioning request for the group of multiple UEs requesting each UE in the group of multiple UEs to determine relative position information relative to each of the other UEs in the group of multiple UEs or means for receiving a positioning request for the group of multiple UEs requesting each UE in the group of multiple UEs to determine position information relative to each of the other UEs in the group of multiple UEs, wherein the reservation message is received after the positioning request (e.g., the ranging component 1354 or the transceiver 1322). The baseband processor 1304 may further include means for receiving, from each UE in the group of multiple UEs, HARQ feedback for at least one of the positioning request or the reservation message and means for transmitting HARQ feedback for the positioning request (e.g., the feedback component 1352 or the transceiver 1322). The baseband processor 1304 may further include means for triggering transmission of a CSI-RS in the TDM resources in response to receiving the reservation message for the TDM resources for the groupcast (e.g., the trigger component 1348 or the transceiver 1322). The baseband processor 1304 may further include means for transmitting HARQ feedback for the DCI in an uplink control channel for the positioning request from each of the UEs in the group (e.g., the feedback component 1352 or the transceiver 1322). The baseband processor 1304 may further include means for transmitting an uplink retransmission in one resource of the TDM resources (e.g., the transceiver 1322). The baseband processor 1304 may further include means for measuring a downlink reference signal from the base station and adjusting for clock drift prior to transmitting in the one resource of the TDM resources reserved for the group of multiple UEs (e.g., the measure component 1344). The means may be one or more of the components of the apparatus 1302 configured to perform the functions recited by the means. As described supra, the apparatus 1302 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 14 is a diagram 1400 illustrating an example of a hardware implementation for an apparatus 1402. The apparatus 1402 may be a base station or a component of a base station. The apparatus 1402 may include a baseband unit 1404. The baseband unit 1404 may communicate through a cellular RF transceiver 1422 with the UE 104. The baseband unit 1404 may include a computer-readable medium/memory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the device 310 and may include the memory 376 and/or at least one of the TX processor 316, the RX processor 370, and the controller/processor 375.

The communication manager 1432 may include a RS component 1442 that may transmit a downlink reference signal from the base station prior to the TDM resources reserved for the group of multiple UEs, e.g., as described in connection with 1202 in FIG. 12. The communication manager 1432 may further include an index component 1444 that may configure indexes for each UE in the group, each index corresponding to an order of transmission in the TDM resources reserved for the group of multiple UEs, e.g., as described in connection with 1204 in FIG. 12. The communication manager 1432 may further include a DCI component 1446 that may transmit DCI comprising a reservation message reserving sidelink resources for groupcasting of one or more reference signals for a group of multiple UEs including the UE, the sidelink resources for the groupcasting comprising TDM resources for the multiple UEs in the group of multiple UEs, e.g., as described in connection with 1206 in FIG. 12. The communication manager 1432 may further include a HARQ component 1448 that may receive HARQ feedback for the DCI in an uplink transmission from each in the group of multiple UEs, e.g., as described in connection with 1208 in FIG. 12. The communication manager 1432 may further include a trigger component 1450 that may trigger the group of multiple UEs to transmit a CSI-RS in the TDM resources based on transmitting the reservation message for the TDM resources for the groupcast, e.g., as described in connection with 1210 in FIG. 12.

The apparatus may include additional components that perform each of the blocks of the algorithm in the flowchart of FIG. 12. As such, each block in the flowchart of FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the baseband unit 1404, includes means for transmitting DCI comprising a reservation message reserving sidelink resources for groupcasting of one or more reference signals for a group of multiple UEs including the UE, the sidelink resources for the groupcasting comprising TDM resources for the multiple UEs in the group of multiple UEs (e.g., such as the DCI component 1446 or the transceiver 1422). The baseband unit 1404 may further include means for receiving HARQ feedback for the DCI in an uplink transmission from each in the group of multiple UEs (e.g., such as the HARQ component 1448 or the transceiver 1422). The baseband unit 1404 may further include means for transmitting a downlink reference signal from the base station prior to the TDM resources reserved for the group of multiple UEs (e.g., such as the RS component 1442 or the transceiver 1422). The baseband unit 1404 may further include means for configuring indexes for each UE in the group, each index corresponding to an order of transmission in the TDM resources reserved for the group of multiple UEs (e.g., such as the index component 1444 or the transceiver 1422). The baseband unit 1404 may further include means for triggering the group of multiple UEs to transmit a CSI-RS in the TDM resources based on transmitting the reservation message for the TDM resources for the groupcast (e.g., such as the trigger component 1450 or the transceiver 1422).

The means may be one or more of the components of the apparatus 1402 configured to perform the functions recited by the means. As described supra, the apparatus 1402 may include the TX Processor 316, the RX Processor 370, and the controller/processor 375. As such, in one configuration, the means may be the TX Processor 316, the RX Processor 370, and the controller/processor 375 configured to perform the functions recited by the means.

Reducing the signaling overhead in the sidelink positioning process may result in a more efficient sidelink positioning process. Aspects provided herein present a framework with cooperative group positioning between UEs with reduced signaling overhead for group scheduling. As presented herein, a UE or a base station may schedule groupcast resources for the group, the resources including TDM resources for each of the UEs in the group. Each of the UEs in the group may transmit, in turn, using one of the TDM resources in order to enable the UEs within the group to determining position information relative to the other UEs within the group.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE, comprising: transmitting a reservation message reserving sidelink resources for groupcasting of one or more reference signals for a group of multiple UEs including the UE, the sidelink resources for the groupcasting comprising TDM resources for the multiple UEs in the group of multiple UEs; and transmitting a reference signal in a resource of the TDM resources.

In aspect 2, the method of aspect 1 further includes measuring reception-transmission (Rx−Tx) time differences for the reference signal from the other UEs in the group of multiple UEs in the remaining TDM resources of the TDM resources.

In aspect 3, the method of aspect 1 or aspect 2 further includes that the TDM resources are consecutive in time.

In aspect 4, the method of aspect 1 or aspect 2 further includes that the TDM resources are non-consecutive in time.

In aspect 5, the method of any of aspects 1-4 further includes that transmitting the reference signal further includes: transmitting the reference signal in the resource based on an index of the UE within the group of multiple UEs.

In aspect 6, the method of aspect 5 further includes receiving a configuration of the index for the UE within the group of multiple UEs.

In aspect 7, the method of any of aspects 1-5 further includes configuring indexes for each UE in the group of multiple UEs, each index corresponding to an order of transmission in the TDM resources reserved for the group of multiple UEs.

In aspect 8, the method of any of aspects 1-8 further includes that the reference signal comprises a demodulation reference signal of a PSSCH.

In aspect 9, the method of any of aspects 1-8 further includes that the reference signal comprises a sidelink CSI-RS.

In aspect 10, the method of any of aspects 1-8 further includes that the reference signal comprises a PRS for sidelink.

In aspect 11, the method of any of aspects 1-10 further includes triggering the UEs in the group of multiple UEs to transmit a CSI-RS in the TDM resources based on transmitting the reservation message for the TDM resources for the groupcast.

In aspect 12, the method of any of aspects 1-11 further includes receiving groupcast transmissions from each UE of the group of multiple UEs in accordance with an associated TDM order representing an order of transmission for the each UE of the group of multiple UEs in the TDM resources, wherein each groupcast transmission reports one or more Rx−Tx time differences for previous groupcasted transmissions in the TDM resources.

In aspect 13, the method of any of aspects 1-12, wherein a later resource in the TDM resources has a bigger size relative to an earlier resource in the TDM resources.

In aspect 14, the method of any of aspects 1-13 further includes transmitting feedback to each of the UEs in the group of multiple UEs in response to receiving a corresponding groupcast transmission.

In aspect 15, the method of any of aspects 1-14 further includes that reservation message includes a group identifier for the group of multiple UEs.

In aspect 16, the method of any of aspects 1-15 further includes that the reservation message indicates a positioning request for the group of multiple UEs requesting each UE in the group of multiple UEs to determine relative position information relative to each of other UEs in the group of multiple UEs.

In aspect 17, the method of any of aspects 1-16 further includes receiving HARQ feedback for the ranging request from each of the UEs in the group.

In aspect 18, the method of any of aspects 1-17 further includes transmitting a positioning request for the group of multiple UEs requesting each UE in the group of multiple UEs to determine relative position information relative to each of the other UEs in the group of multiple UEs, wherein the reservation message is transmitted after the positioning request.

In aspect 19, the method of any of aspect 18 further includes receiving, from each UE in the group of multiple UEs, HARQ feedback for at least one of the ranging request or the reservation message.

Aspect 20 is an apparatus for wireless communication at a UE, comprising means to perform the method of any of aspects 1-19.

Aspect 21 is an apparatus for wireless communication at a UE, comprising memory and at least one processor coupled to the memory, the memory and the at least one processor being configured to perform the method of any of aspects 1-19.

Aspect 22 is a non-transitory computer-readable storage medium storing computer executable code at a wireless device, the code when executed by a processor causes the processor to perform the method of any of aspects 1-19.

Aspect 23 is a method of wireless communication at a UE, comprising: receiving a reservation message reserving sidelink resources for groupcasting of one or more reference signals for a group of multiple UEs including the UE, the sidelink resources for the groupcasting comprising TDM resources for the multiple UEs in the group of multiple UEs; and transmitting a reference signal in a resource of the TDM resources.

In aspect 24, the method of aspect 23 further includes that the reservation message is from one of the UEs in the group of multiple UEs.

In aspect 25, the method of aspect 23 or aspect 24 further includes measuring reception-transmission (Rx−Tx) time differences for TDM transmissions of the reference signal from other UEs in the group of multiple UEs in remaining TDM resources reserved by the UE.

In aspect 26, the method of any of aspects 23-25 further includes that the TDM resources are consecutive in time.

In aspect 27, the method of any of aspects 23-25 further includes that the TDM resources are non-consecutive in time.

In aspect 28, the method of any of aspects 23-27 further includes transmitting the reference signal in the resource based on an index of the UE within the group of multiple UEs.

In aspect 29, the method of aspect 28 further includes receiving a configuration of the index for the UE within the group of multiple UEs.

In aspect 30, the method of any of aspects 23-29 further includes that the reference signal comprises a demodulation reference signal of a PSSCH.

In aspect 31, the method of any of aspects 23-29 further includes that the reference signal comprises a sidelink CSI-RS.

In aspect 32, the method of any of aspects 23-29 further includes that the reference signal comprises a PRS for sidelink.

In aspect 33, the method of any of aspects 23-32 further includes triggering transmission of a CSI-RS or a PRS for sidelink in the TDM resources in response to receiving the reservation message for the TDM resources for the groupcast.

In aspect 34, the method of any of aspects 23-33 further includes receiving groupcast transmissions from each UE of the group of multiple UEs in accordance with an associated TDM order representing an order of transmission for the each UE of the group of multiple UEs in the TDM resources, wherein each groupcast transmission reports one or more reception-transmission (Rx−Tx) time differences for previous groupcasted transmissions in the TDM resources.

In aspect 35, the method of any of aspects 23-34 wherein a later resource in the TDM resources has a bigger size relative to an earlier resource in the TDM resources.

In aspect 36, the method of any of aspects 23-35 further includes that the reservation message includes a group identifier for the group of multiple UEs.

In aspect 37, the method of any of aspects 23-36 further includes that the reservation message indicates a positioning request for the group of multiple UEs requesting each UE in the group of multiple UEs to determine relative position information relative to each other UEs in the group of multiple UEs.

In aspect 38, the method of any of aspects 23-37 further includes transmitting HARQ feedback for the ranging request.

In aspect 39, the method of any of aspects 23-36 further includes receiving a positioning request for the group of multiple UEs requesting each UE in the group of multiple UEs to determine position information relative to each other UEs in the group of multiple UEs, wherein the reservation message is received after the positioning request.

In aspect 40, the method of aspect 39 further includes transmitting HARQ feedback for at least one of the ranging request or the reservation message.

In aspect 41, the method of any of aspects 23 or 24-39 further includes that the reservation message is comprised in DCI from a base station.

In aspect 42, the method of aspect 41 further includes transmitting HARQ feedback for the DCI in an uplink control channel.

In aspect 43, the method of aspect 41 or aspect 42 further includes transmitting an uplink retransmission in one resource of the TDM resources.

In aspect 44, the method of any of aspects 41-43 further includes measuring a downlink reference signal from the base station; and adjusting for clock drift prior to transmitting in the one resource of the TDM resources reserved for the group of multiple UEs.

Aspect 45 is an apparatus for wireless communication at a UE, comprising means to perform the method of any of aspects 23-44.

Aspect 46 is an apparatus for wireless communication at a UE, comprising memory and at least one processor coupled to the memory, the memory and the at least one processor being configured to perform the method of any of aspects 23-44.

Aspect 47 is a non-transitory computer-readable storage medium storing computer executable code at a wireless device, the code when executed by a processor causes the processor to perform the method of any of aspects 23-44.

Aspect 48 is a method of wireless communication at a base station, comprising: transmitting DCI comprising a reservation message reserving sidelink resources for groupcasting of one or more reference signals for a group of multiple UEs including the UE, the sidelink resources for the groupcasting comprising TDM resources for the multiple UEs in the group of multiple UEs; and receiving HARQ feedback for the DCI in an uplink transmission from each in the group of multiple UEs.

In aspect 49, the method of aspect 48 further includes transmitting a downlink reference signal from the base station prior to the TDM resources reserved for the group of multiple UEs.

In aspect 50, the method of aspect 48 or aspect 49 further includes triggering the group of multiple UEs to transmit a CSI-RS in the TDM resources based on transmitting the reservation message for the TDM resources for the groupcast.

In aspect 51, the method of aspect 48 or aspect 49 further includes triggering the group of multiple UEs to transmit a PRS for sidelink in the TDM resources based on transmitting the reservation message for the TDM resources for the groupcast.

In aspect 52, the method of any of aspects 48-51 wherein a later resource in the TDM resources has a bigger size relative to an earlier resource in the TDM resources.

In aspect 53, the method of any of aspects 48-52 further includes that the reservation message includes a group identifier for the group of multiple UEs.

In aspect 54, the method of any of aspects 48-53 further includes that the TDM resources are consecutive in time.

In aspect 55, the method of any of aspects 48-53 further includes that the TDM resources are non-consecutive in time.

In aspect 56, the method of any of aspects 48-55 further includes that configuring indexes for each UE in the group, each index corresponding to an order of transmission in the TDM resources reserved for the group of multiple UEs.

Aspect 57 is an apparatus for wireless communication at a base station, comprising means to perform the method of any of aspects 48-56.

Aspect 58 is an apparatus for wireless communication at a base station, comprising memory and at least one processor coupled to the memory, the memory and the at least one processor being configured to perform the method of any of aspects 48-56.

Aspect 59 is a non-transitory computer-readable storage medium storing computer executable code at a wireless device, the code when executed by a processor causes the processor to perform the method of any of aspects 48-56.

1. An apparatus of wireless communication at a user equipment (UE), comprising:
memory; and
one or more processors coupled to the memory and, based at least in part on information stored in the memory, configured to cause the UE to:
transmit a reservation message configured to reserve sidelink resources for groupcast of one or more reference signals for a group of multiple UEs including the UE, the sidelink resources for the groupcast comprising time division multiplexed (TDM) resources for the multiple UEs in the group of multiple UEs; and
transmit a reference signal in a resource of the TDM resources associated with the UE.

2. The apparatus of claim 1, further comprising:
one or more antennas coupled to the one or more processors, wherein the one or more processors are further configured to cause the UE to:
receive an additional reference signal, from other UEs in the group of multiple UEs, in remaining TDM resources of the TDM resources; and
measure reception-transmission (Rx−Tx) time differences for the reference signal from the other UEs in the group of multiple UEs in the remaining TDM resources of the TDM resources.

3. The apparatus of claim 1, wherein to transmit the reference signal, the one or more processors are configured to cause the UE to:
transmit the reference signal in the resource based on an index of the UE within the group of multiple UEs.

4. The apparatus of claim 1, wherein the reference signal comprises a demodulation reference signal of a physical sidelink shared channel (PSSCH).

5. The apparatus of claim 1, wherein the reference signal comprises a sidelink channel state information reference signal (CSI-RS) or a positioning reference signal (PRS) for sidelink.

6. The apparatus of claim 1, wherein the one or more processors are further configured to cause the UE to:
receive groupcast transmissions from each UE of the group of multiple UEs in an associated TDM order representing an order of transmission for each UE of the group of multiple UEs in the TDM resources, wherein each groupcast transmission reports one or more reception-transmission (Rx−Tx) time differences for one or more previous groupcast transmissions in the TDM resources.

7. The apparatus of claim 6, wherein a later resource in the TDM resources has a bigger size relative to an earlier resource in the TDM resources.

8. The apparatus of claim 1, wherein the reservation message includes a group identifier for the group of multiple UEs.

9. The apparatus of claim 8, wherein the reservation message indicates a positioning request for the group of multiple UEs, the positioning request configured to request each UE in the group of multiple UEs to determine relative position information relative to each of other UEs in the group of multiple UEs.

10. The apparatus of claim 8, wherein the one or more processors are further configured to cause the UE to:
transmit a positioning request for the group of multiple UEs requesting each UE in the group of multiple UEs to determine relative position information relative to each of other UEs in the group of multiple UEs, wherein the reservation message is after the positioning request.

11. An apparatus of wireless communication at a user equipment (UE), comprising:
memory; and
one or more processors coupled to the memory and, based at least in part on information stored in the memory, configured to cause the UE to:
receive a reservation message configured to reserve sidelink resources for groupcast of one or more reference signals for a group of multiple UEs including the UE, the sidelink resources for the groupcast comprising time division multiplexed (TDM) resources for the multiple UEs in the group of multiple UEs; and
transmit a reference signal in a resource of the TDM resources.

12. The apparatus of claim 11, further comprising: one or more antennas coupled to the one or more processors, wherein the reservation message is from one of the UEs in the group of multiple UEs.

13. The apparatus of claim 11, wherein the one or more processors are further configured to cause the UE to:
measure reception-transmission (Rx−Tx) time differences for TDM transmissions of the reference signal from other UEs in the group of multiple UEs in remaining TDM resources of the TDM resources.

14. The apparatus of claim 11, wherein to transmit the reference signal, the one or more processors are further configured to cause the UE to:
transmit the reference signal in the resource based on an index of the UE within the group of multiple UEs.

15. The apparatus of claim 14, wherein the one or more processors are further configured to cause the UE to:
receive a configuration of the index for the UE within the group of multiple UEs.

16. The apparatus of claim 11, further comprising:
trigger transmission of a channel state information reference signal (CSI-RS) or a positioning reference signal (PRS) for sidelink in the TDM resources in response to reception of the reservation message for the TDM resources for the groupcast.

17. The apparatus of claim 11, further comprising:
receive groupcast transmissions from each UE of the group of multiple UEs in accordance with an associated TDM order, wherein the TDM order represents an order of transmission for each UE of the group of multiple UEs in the TDM resources, wherein each groupcast transmission reports one or more reception-transmission (Rx−Tx) time differences for one or more previous groupcast transmissions in the TDM resources.

18. The apparatus of claim 17, wherein the TDM resources have a size that increases over time.

19. The apparatus of claim 11, wherein the reservation message includes a group identifier for the group of multiple UEs.

20. The apparatus of claim 19, wherein the reservation message indicates a positioning request for the group of multiple UEs requesting each UE in the group of multiple UEs to determine relative position information relative to each other UEs in the group of multiple UEs.

21. The apparatus of claim 19, wherein the one or more processors are further configured to cause the UE to:
receive a positioning request for the group of multiple UEs, wherein the positioning request is configured to request each UE in the group of multiple UEs to determine position information relative to each other UEs in the group of multiple UEs, wherein the reservation message is after the positioning request.

22. The apparatus of claim 11, wherein the reservation message is comprised in downlink control information (DCI) from a base station.

23. The apparatus of claim 22, wherein the one or more processors are further configured to cause the UE to:
transmit hybrid automatic repeat request (HARQ) feedback for the DCI in an uplink control channel.

24. The apparatus of claim 22, wherein the one or more processors are further configured to cause the UE to:
transmit an uplink retransmission in one resource of the TDM resources.

25. The apparatus of claim 22, wherein the one or more processors are further configured to cause the UE to:
measure a downlink reference signal from the base station; and
adjust for clock drift prior to transmission in the one resource of the TDM resources.

26. An apparatus of wireless communication at a network node, comprising:
memory; and
one or more processors coupled to the memory and, based at least in part on information stored in the memory, configured to cause the network node to:
transmit downlink control information (DCI) comprising a reservation message configured to reserve sidelink resources for groupcast of one or more reference signals for a group of multiple UEs, the sidelink resources comprising time division multiplexed (TDM) resources for the group of multiple UEs; and
receive hybrid automatic repeat request (HARQ) feedback for the DCI in an uplink transmission from each UE in the group of multiple UEs.

27. The apparatus of claim 26, further comprising one or more antennas coupled to the one or more processors, wherein the one or more processors are further configured to cause the network node to:
transmit a downlink reference signal prior to the TDM resources.

28. The apparatus of claim 26, wherein the one or more processors are further configured to cause the network node to:
trigger the group of multiple UEs to transmit a channel state information reference signal (CSI-RS) or a positioning reference signal (PRS) for sidelink in one resource of the TDM resources based on transmission of the reservation message for the TDM resources for the groupcast.

29. The apparatus of claim 26, wherein a later resource in the TDM resources has a bigger size relative to an earlier resource in the TDM resources.

30. The apparatus of claim 26, wherein the reservation message includes a group identifier for the group of multiple UEs.
